(19) United States
(12) Patent Application Publication
(10) Pub. No.: US 2017/0239147 A1
(43) Pub. Date: Aug. 24, 2017

(54) Shield for Reconstructed Nipple

(71) Applicant: Magdalena Dickson, Bradenton, FL (US)

(72) Inventor: Magdalena Dickson, Bradenton, FL (US)

(21) Appl. No.: 15/591,277

(22) Filed: May 10, 2017

Related U.S. Application Data
(63) Continuation-in-part of application No. 14/658,231, filed on Mar. 15, 2015, now Pat. No. 9,649,260.

(51) Int. Cl. A61J 13/00

(52) U.S. Cl. CPC A61J 13/00

(57) ABSTRACT

A shield for a post-operative reconstructed nipple is disclosed. The shield includes a surrounding wall that is open on the top and bottom, and a hexagonal flat base with rounded corners and symmetric suture holes. The shield is made of polyethylene or other semi-rigid material. The shield is sutured to a patient's skin through the suture holes.

### CROSS-REFERENCE TO RELATED APPLICATIONS

This application is a continuation-in-part of application Ser. No. 14/658,231, filed Mar. 15, 2015.

### BACKGROUND

1. Field of Invention

This invention pertains to a shield for protecting a post-surgical wound. More particularly, this disclosure pertains to an open-end shield sutured to the portion of a patient's skin that surrounds a reconstructed nipple.

2. Description of the Related Art

The current preferred method for nipple reconstruction is to make small incisions on the skin of a breast that has been reconstructed either by autologous reconstruction or breast implant. The cut tissue is then elevated, and formed and shaped into a living tissue projection that mimics the natural nipple. A common incision/elevation method is the “star” dermal flap pattern, which comprises elevation of the skin flaps of the cut “star” pattern and wrapping the star “wings” around each other.

Nipple construction is the last stage of breast reconstruction and is performed when the surgeon is confident that the prior reconstruction stages have sufficiently healed and that both the contour and shape of the reconstructed breast have achieved their final acceptable symmetry.

The technical challenges of nipple reconstruction include maintaining a desirable nipple projection and leaving an inconspicuous scar. Tissue heals in response to the forces that are placed upon it and the position the tissue is in. Thus, during the post-operative stage the protection of a newly created nipple from outside forces is crucial. A newly constructed nipple is extremely sensitive to shearing and pressure forces, which may result in flattening of a nipple.

Typical prior art for shielding nipples is found in, for example, U.S. Pat. No. 4,870,977 by Imonti (hereinafter “Imonti”), which discloses a cone-shaped nipple protector member having an outwardly-disposed flange. More recent art is found in U.S. Pat. No. 7,938,122 by Clark (hereinafter “Clark”), which discloses a nipple guard with a hollow core component, padding, and adhesive tape.

Both Imonti and Clark's devices may be appropriate for protecting a post-operative nipple under certain circumstances but do not fully address many of the collateral concerns related to the nipple healing process. For example, the earlier art by Imonti does not allow cleansing and proper medication ointment application without removal of the protector, and the slope of Imonti's cone-shaped nipple guards prevents effective cleaning by making it more difficult to insert a cleaning implement into the area around the nipple. As another example, both of the cited prior arts ordinarily use anchoring devices such as tape, which may produce allergic reactions in a patient and not adhere to skin correctly. Moreover, the devices taught by Imonti and Clark cover more skin tissue than may be necessary, thereby preventing proper air circulation on the tissue and creating constant moisture around the wound areas. In addition, Clark's device requires that the guard be changed “one to two times per day for up to sixteen weeks or longer,” rather than use one guard that may be used for the entire recovery period. See Clark, Col. 8, 1. 48-50. Requiring so many changes will either reduce average patient compliance from missed appointments, or increase the likelihood of patient error if the patient is the one responsible for changing the guard.

### BRIEF SUMMARY

According to one embodiment of the present invention, a shield is provided. The shield includes a hexagonal base with rounded corners and at least one adjacent wall extending from the base. The wall is sized to surround a patient's post-surgical wound. The base is perpendicular to the wall.

The base has a front-back and left-right symmetry. The wall is centered on the base. The base includes a left tab and a right tab. Two of the four apertures are on the left tab, and two of the four apertures are on the left tab. Both the base and the wall are essentially inflexible.

In one embodiment, the wall is a cylinder with a top end and a bottom end. The cylinder is open on both ends and sized to encase a patient's post-surgical wound. The base is perpendicular to the cylinder.

The base includes four apertures. The centers of the four apertures define the corners of a rectangle whose short sides are shorter than the cylinder outer diameter and whose long sides are longer that the cylinder outer diameter. The apertures are operable to allow a suture needle to pass through each of said apertures and secure said shield to a patient's skin with sutures.

In other embodiments, the shield protects a post-surgical body portion other than a reconstructed nipple. For example, in one embodiment, the shield protects an incision area resulting from an invasive surgery. In another embodiment, the shield protects a connection wound resulting from a reattachment surgery.

The present disclosure provides, in one embodiment, a shield that allows a post-operation reconstructed nipple to heal properly.

The present disclosure provides, in one embodiment, a shield that is easy to clean.

The present disclosure provides, in one embodiment, a shield that allows the patient to take a shower the first day after surgery.

The present disclosure provides, in one embodiment, a shield that allows the protected wound to dry properly.

The present disclosure provides, in one embodiment, a shield that allows easy access and drying, cleaning, and medication application on the reconstructed nipple and surrounding area without requiring removal of the shield.

The present disclosure provides, in one embodiment, a shield that does not require removal or replacement during its use.

The present disclosure provides, in one embodiment, a shield made of strong durable material that may be affixed firmly in a single position and not subject to dislodging, torquing, rotating or shifting from external jostling caused by clothing, bras, or sleeping on one's stomach.

The present disclosure, in one embodiment, prevents necrosis as a result of poor healing, detachment, and lack of blood flow caused by shearing forces.

The present disclosure provides, in one embodiment, a shield that is affixed easily to a patient.

The present disclosure provides, in one embodiment, a shield that is removed easily from a patient.

The present disclosure provides, in one embodiment, a cost-effective shield.

The present disclosure provides, in one embodiment, a shield that does not require tape to affix the shield to the patient's skin.

The present disclosure provides, in one embodiment, a shield that covers a minimal amount of skin tissue.

The present disclosure provides, in one embodiment, a shield that properly protects the post-operation nipple from flattening.

The present disclosure provides, in one embodiment, a shield that improves patient compliance and reduces patient error by requiring less changing of the shield.

The present disclosure provides, in one embodiment, a patient with the psychological benefit of achieving realistic-looking breasts after undergoing reconstructive nipple surgery.

The present disclosure, in one embodiment, allows a post-surgical wound to heal without the use of lining, padding, or adhesives, which cause allergic reaction in some patients.

As used herein, positional terms such as “top”, “bottom”, “right”, “left”, “front”, and “back” are relative within the disclosed drawings as labeled, and not intended to be absolute. The positional terms are only meant to provide a frame of reference for the displayed embodiments rather than how the embodiments may be positioned when in use. For example, left tab 120 and right tab 122 may in fact be positioned such that they define a patient's sagittal plane (i.e., a vertically for a standing patient) rather than the patient's transverse plane.

### BRIEF DESCRIPTION OF THE SEVERAL VIEWS OF THE DRAWINGS

The above-mentioned features will become more clearly understood from the following detailed description read together with the drawings in which:

FIG. 1 is a top perspective view of an embodiment of a shield.

FIG. 2 is a top view of the embodiment of FIG. 1.

FIG. 3 is a bottom view of the embodiment of FIG. 1.

FIG. 4 is a front view of the embodiment of FIG. 1, sutured to a patient's skin.

FIG. 5 is a side view of the embodiment of FIG. 1.

FIG. 6 is a side cross-section view of the embodiment of FIG. 1.

FIG. 7 is a side perspective cross-section view of the embodiment of FIG. 1.

FIG. 8 is a side view of another embodiment of a shield.

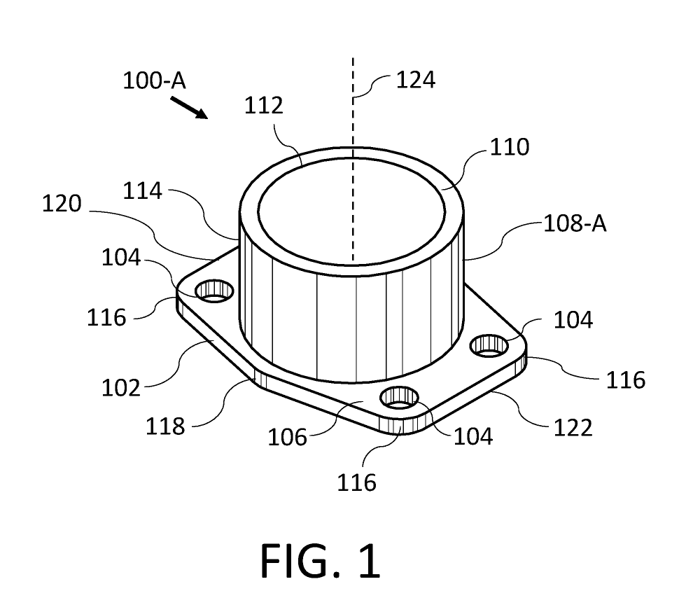

The apparatus for shielding post-operative nipple reconstruction is disclosed. The shield is generally indicated as 100, with various embodiments designated with a letter suffix, e.g., 100-A and 100-B. The shield 100 is configured to protect a healing nipple. In other embodiments, the shield 100 is shaped to protect other post-surgical wounds.

In one embodiment the shield 100 is contained in packaging that allows the shield to remain sterile prior to use. In one method of use, the shield 100 is used on a single patient over a period of days or weeks.

The shield 100 is made of one single molded piece or a combination wall 108 fused to an anchor/base 102. The base 102 includes a left and right tab 120, 122. The wall 108-A defines a cylinder. In other embodiments, the wall 108 is another ordinary shape, such as an oval or square. In other embodiments, the wall 108 is configured such that the inner wall is slightly larger than the surgical wound it is protecting. In other embodiments, such as shown in FIG. 8, the wall 108-B includes gaps 802.

In some embodiments, the shield material is homogenous, thereby allowing for a simpler manufacturing process. The shield material is sufficiently light such that it does not substantially deform the skin when the shield is pulled by gravity. The shield material is inert. The shield material is composed of matter that is chemically nonreactive with a patient's skin. The shield material is capable of being molded to have a smooth surface. The shield material does not have a molecular structure susceptible to shattering. The shield material is resistant to puncturing. For example, in one embodiment the shield 100 consists of a plastic similar to the types of polyethylene plastics found in syringes. In another embodiment, the shield material is silicon, with a hardness similar to that of the silicon found in nursing shields. The thickness of both the wall 108 and the base 102 are sufficient such that both the wall 108 and the base 102 are essentially rigid and inflexible, i.e., neither the base bottom surface 302 nor the wall 108 are subject to bending or misshaping when sutured to a patient. The base bottom surface 302 is flat rather than dome-shaped, thereby avoiding a suction effect and avoiding the base 102 edges pressing into the patient's skin or incisions. Stability is also increased. The base bottom surface 302 is smooth, thereby avoiding patient discomfort or damage to the patient's skin.

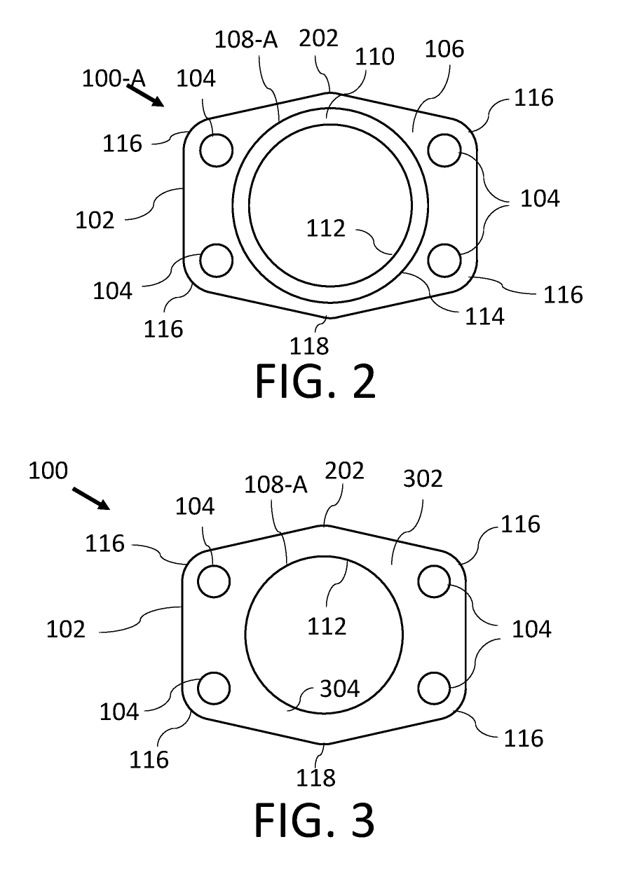

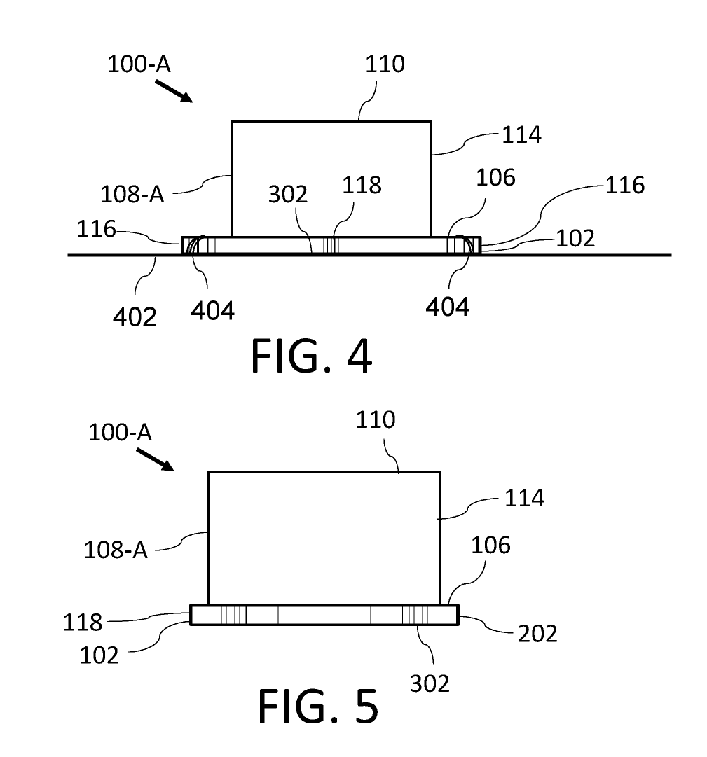

As shown in FIG. 2, the shield 100 has both front-to-back and left-to-right reflection symmetry. The shield 100 has rotational symmetry about a center axis 124 of the inner surface 112 of the wall 108-A. The symmetric location of the suture holes 104 about the outer surface 114 of the wall 108 ensures that the static equilibrium of the sutures 404 is centered about the axis of the wall 108, thereby increasing stability and resistance to jostling from any direction. As a result of the symmetry, a surgeon affixes the shield 100 to a patient without having to consider or remember extra positioning requirements. In other embodiments, the shield 100 is not symmetrical and is configured to surround a particular wound shape.

Base 102 includes at least four suture holes 104 that pass orthogonally from the base top surface 106 to the base bottom surface 302 and that are of sufficient diameter relative to base 102 thickness such that a desired curved suture needle is able to pass through the suture hole 104. In one embodiment, the suture holes 104 depths and widths are sized such that a standard ⅜ suture needle fits through each hole 104. The base top and bottom surfaces 106, 302 are parallel. The base 102 is solid between base top and bottom surfaces 106, 302. Suture holes 104 are aligned such that the centers of the holes 104 collectively define the corners of a rectangle.

Each of the four suture holes 104 is between a corresponding rounded corner 116 and the wall 108. Two holes are on each tab 120, 122.

In order to minimize the skin area covered by the embodiment during use, base 102 is sufficiently narrow such that wall outer surface 114 is completely interposed between left and right side suture holes 104, and completely interposed between right and left side and rounded corners 116. The wall outer surface 114 is not interposed between at least a portion of the suture holes 104 on the left tab 120. The wall outer surface 114 is not interposed between at least a portion of the suture holes 104 on the right tab 122.

Front and rear rounded corners 118, 202 are located on opposite sides of the outer surface 114 of the wall 108 and each are a minimal distance from the wall 108 such that suture holes 104 would not fit between wall 108 and rounded corners 118, 202. There is, however, enough distance between wall 108 and rounded corners 118, 202 to allow for structural integrity of the device and allow for a flat surface such that wall bottom surface 304 alone does not press into the patient's skin.

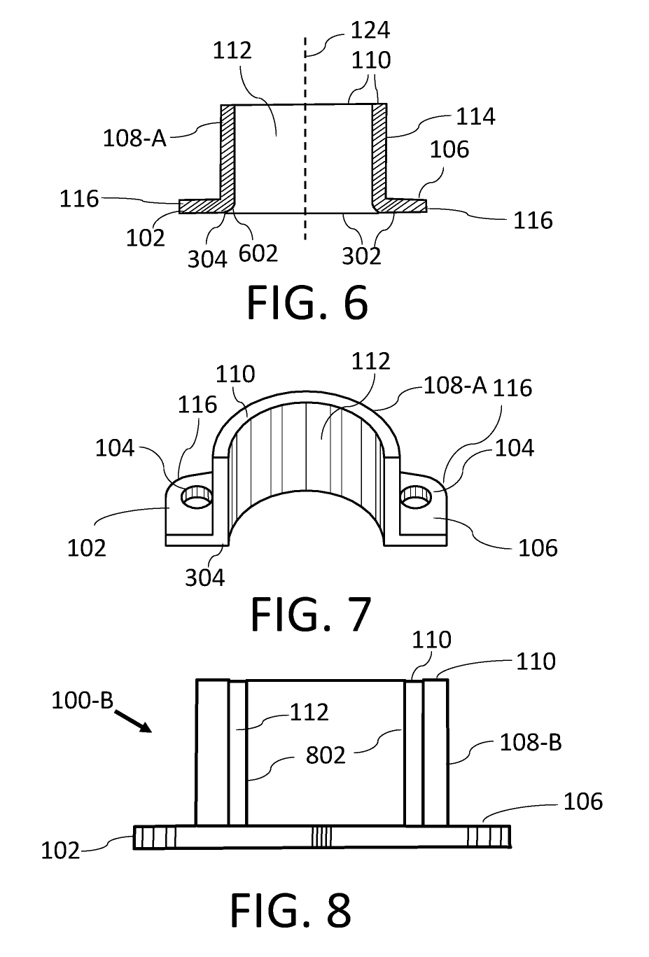

As shown in FIGS. 6 and 7, wall inner surface 112 is not sloped but rather uniformly perpendicular with base 102. Wall inner surface 112 has a diameter that is at least large enough such that wall 108-A encircles and does not touch the reconstructed nipple. The bottom edge 602 of wall inner surface 112 is beveled such that it does not press into the patient's skin. The height of wall 108 is such that wall top surface 110 is higher than the top of the surgical wound, e.g., the reconstructed nipple, that the shield 100 is protecting. The inner surface 112 diameter accounts for the fact that the reconstructed nipple will be swollen immediately after surgery. The inner surface 112 is smooth, thereby preventing abrasion and damage to the healing wound.

FIG. 8 displays an embodiment 100-B. The wall 108-B includes slits 802. The slits 802 are longitudinal. The slits 802 extend from the base top surface 106 to the wall top surface 110. In other embodiments, the slits 802 do not extend fully to the base top surface 106. The slits 802 allow for greater air flow around the patient's wound while being sufficiently narrow to prevent objects from contacting the wound.

In an exemplary protoctol, a surgeon uses the shield 100 immediately following a surgical procedure. The surgeon applies, for example, an iodiform gauze or other thin dressing type of choice on the skin around the nipple, and then places the shield 100 on the gauze such that the incisions on the sides of the newly formed nipple do not directly touch the shield.

A 2-inch square iodiform gauze, for example, is fitted directly between the base 102 and the patient's incisions, i.e., the base 102 is imposed on the iodiform gauze. However, each surgeon has his or her own style of wound dressing and may use different dressing, other dressing patterns, or no dressing at all.

The surgeon then uses, for example, a ⅜ suture needle and suture thread 404 to suture the shield 100 to the patient's skin 402 through the suture holes 104. The sutures 404 should be short and binding enough so that the shield 100 cannot contact the reconstructed nipple even when lateral or torque forces are exerted against the wall top surface 110.

In this method embodiment, affixing the shield is performed as outpatient surgery. The patient has the option of showering the night of surgery or the following morning. Medication or disinfectant is applied to the reconstructed nipple without removing or unsuturing the shield 100.

From the foregoing description, it will be recognized by those skilled in the art that a simple, sturdy disposable shield for post-surgical wounds has been provided.

While the present inventions have been illustrated by embodiments and while the illustrative embodiments have been described, it is not the intention of the applicant to restrict or in any way limit the scope of the appended claims to such detail. Additional advantages and modifications will readily appear to those skilled in the art. The inventions in their broader aspects are therefore not limited to the specific details, representative apparatus and methods, and illustrative examples shown and described. Accordingly, departures may be made from such details without departing from the spirit or scope of applicant's general inventive concepts.

What is claimed is:

1. A shield for a post-surgical reconstructed nipple, said shield comprising:
a base that includes a top surface, a bottom surface, a first, second, third and fourth suture hole, a first, second, third and fourth rounded corner, and a fifth and sixth rounded corner; and
a cylinder that includes a top surface, a bottom surface, an inner circumference and an outer circumference;
wherein
said base top surface is parallel to said base bottom surface;
said cylinder is perpendicular to said base bottom surface;
said cylinder is adjacent to and contiguous with said base top surface;
said cylinder top surface is above said base top surface;
said bottom surface of said base is flat;
said cylinder inner circumference is smooth;
said cylinder bottom surface is parallel to and contiguous with said base bottom surface;
said first suture hole is between said cylinder and said first rounded corner;
said second suture hole is between said cylinder and said second rounded corner;
said third suture hole is between said cylinder and said third rounded corner;
said fourth suture hole is between said cylinder and said fourth rounded corner;
said fifth and sixth rounded corners are located on opposite sides of said cylinder outer circumference;
said cylinder is between said first and second suture holes, and said cylinder is between said third and fourth suture holes;
said cylinder is not between at least a portion of said first and third suture holes, and said cylinder is not between at least a portion of said second and fourth suture holes;
the diameter of said inner circumference is greater than the diameter of the reconstructed nipple;
the distance between said cylinder top surface and said cylinder bottom surface is greater than the height of the reconstructed nipple;
the centers of said four suture holes collectively define the corners of a rectangle;
said base is essentially inflexible; and
said cylinder is essentially inflexible.

2. The shield of claim 1, said shield consists of a single material, said material is sufficiently light such that the weight of said shield does not substantially deform the patient's skin, said shield material is inert and nonreactive when in contact with the patient's skin.

3. The shield of claim 1, wherein a bottom edge of said cylinder inner circumference is beveled.

4. The shield of claim 1, said base is a hexagon with rounded corners.

5. The shield of claim 1, said shield is symmetrical about an axis of said cylinder.

6. The shield of claim 1, wherein each of said four suture holes is of sufficient size for a ⅜ suture needle to pass completely though each of said holes.

7. The shield of claim 1, wherein the minimum distance between said fifth corner and said outer circumference of said cylinder is less than the diameter of each of said four suture holes.

8. A shield for post-surgical healing, comprising:
a wall with a top end and a bottom end, said wall is configured to encircle a patient's post-surgical wound, said wall is open on both ends;
a flange located at said wall bottom end, wherein said flange includes four suture holes and is perpendicular to said wall;
wherein the centers of said four suture holes define the corners of a rectangle whose short sides are shorter than an outer diameter of the wall and whose long sides are longer that an outer diameter of the wall; and
whereby said suture holes are sized to allow a suture needle to pass through each of said holes and secure said shield to a patient's skin with sutures.

9. The shield of claim 8, said wall includes slits, said slits extend from said wall top end to said flange, said slits are perpendicular to said flange.

10. The shield of claim 8, said left tab includes two of said four suture holes, said right tab includes two of said four suture holes.

11. The shield of claim 10, said wall is interposed between said suture holes on said left tab and said suture holes on said right tab.

12. The shield of claim 8, wherein a cross-section of said wall defines an oval.

13. The shield of claim 8, said shield is inert and nonreactive when in contact with the patient's skin.

14. A shield for a patient's post-surgical wound, comprising:
a wall, said wall is has a top surface, a bottom surface, an inner surface, and an outer surface said wall is sized to surround a patient's surgical wound,
an anchor, said anchor has a top surface and a bottom surface, said bottom surface of said wall is adjacent to, surrounded by, and in contact with said bottom surface of said anchor, said inner wall is perpendicular to said anchor;
said wall inner surface defines an opening of uniform width extending from said wall top surface to said wall bottom surface,
said wall top surface is higher than the patient's post-surgical wound;
said anchor bottom surface is flat and smooth, said wall inner surface is smooth, said anchor top surface is parallel to said anchor bottom surface;
said anchor includes a first hole, a second hole, a third hole, and a fourth hole, wherein each of said four anchor holes extend from said anchor top to said anchor bottom surface, each of said four holes are configured to receive a suture needle;
said outer surface of said container is between said first and second holes, said outer surface of said container is between said third and fourth holes, said outer surface of said container is between said first and third holes, said outer surface of said container is not between at least a portion of said first and third holes.

15. The shield of claim 14, said anchor includes a first, a second, a third, a fourth, a fifth, and a sixth rounded corner, said first hole is between said wall and said first rounded corner, said second hole is between said wall and said second rounded corner, said third hole is between said wall and said third rounded corner, said fourth hole is between said wall and said fourth rounded corner, said fifth and sixth rounded corners are located on opposite sides of said wall outer surface.

16. The shield of claim 15, said anchor is a hexagon with rotational symmetry.

17. The shield of claim 14, further comprising suture thread, said first, second, third, and fourth holes are suture holes, said suture thread extends through said suture holes and affixes said anchor to the patient.

18. The shield of claim 14, wherein the centers of said first, second, third, and fourth holes collectively define the corners of a rectangle, said anchor is solid between said anchor top surface and said anchor bottom surface.

19. The shield of claim 14, wherein the minimum distance between said fifth corner and said outer surface of said wall is less than a diameter of said first hole.

20. The shield of claim 14, said anchor is essentially inflexible.
